(19) United States
(12) Patent Application Publication
(10) Pub. No.: US 2013/0138943 A1
(43) Pub. Date: May 30, 2013

(54) SEMICONDUCTOR INTEGRATED CIRCUIT DEVICE AND ELECTRONIC SYSTEM MOUNTED THE SEMICONDUCTOR INTEGRATED CIRCUIT DEVICE

(71) Applicant: Fujitsu Limited, Kawasaki-shi (JP)

(72) Inventors: Junji ICHIMIYA, Yokohama (JP); Masahiro Nishio, Yokohama (JP); Hiroshi Nakayama, Yokohama (JP); Jin Takahashi, Bunkyo (JP); Shintaro Itozawa, Kawasaki (JP)

(73) Assignee: Fujitsu Limited, Kawasaki-shi (JP)

(21) Appl. No.: 13/748,793

(22) Filed: Jan. 24, 2013

Related U.S. Application Data
(63) Continuation of application No. PCT/JP2010/063421, filed on Aug. 6, 2010.

(51) Int. Cl. G06F 9/44

(52) U.S. Cl. CPC G06F 9/4401
USPC 713/2

(57) ABSTRACT

An electronic system has a plurality of semiconductor integrated circuit deices which are connected in series via a single signal line. One semiconductor integrated circuit device of the plurality of semiconductor integrated circuit devices sequentially reads the setting data of each of the plurality of the semiconductor integrated circuit devices from a storage unit, sets the setting data of the one semiconductor integrated circuit device to a functional circuit of the one semiconductor integrated circuit device, and transfers second setting data of another semiconductor integrated circuit device to the another semiconductor integrated circuit device via the single signal line.

### CROSS-REFERENCE TO RELATED APPLICATION

This application is a continuation application of International Application PCT/JP2010/063421 filed on Aug. 6, 2010 and designated the U.S., the entire contents of which are incorporated herein by reference.

### FIELD

The embodiments discussed herein are related to a semiconductor integrated circuit device and an electronic system mounted the semiconductor integrated circuit device.

### BACKGROUND

An electronic system has a LSI (Large Scale Integrated Circuit) provided with a functional circuit which performs a predetermined function. The LSI is referred to a semiconductor integrated circuit device (a semiconductor circuit chip). The electronic system realizes a predetermined function by connecting a plurality of the LSI. The LSI has a variety of setting values in itself. The LSI changes the operation in various way according to the setting values. For examples, a computer system has arithmetic processing units (CPUs: Central Processing Units), a memory access controller and a memory, as the LSI.

For example, as this setting values of the LSI, one is to depend on a board design with a computer system, and another is to depend on device configuration in the computer system. At a stage of designing the LSI (a semiconductor integrated circuit), some values among these setting values were not uniquely determined the value. From a consideration of design period or a consideration of avoiding problems caused by lack of thinking during the design, it is general to set this setting value by a system after designing the LSI (semiconductor integrated circuit device) and constructing the electronic system. For example, the above described memory access controller requires a setting value depending on a type of memory which is connected, a speed of the memory, and the number of memory, etc.

FIG. 15 is an explanation diagram of a conventional setting method of the setting value of the LSI. As illustrated in FIG. 15, a plurality of LSI 110, 120 and 130 are installed on same or different system boards. A system management device 100 is a device that manages the entire system. The system management device 100 connects to the LSI 110, 120 and 130 through system interface bus 140.

In the electronic system illustrated by FIG. 15, after each LSI (semiconductor integrated circuit) 110, 120 and 130 oscillates internal clocks and reaches to a status that registers in the LSI 110, 120 and 130 makes to writable, the system management device 100 writes the setting values into the registers in each LSI (semiconductor integrated circuit device) 110, 120, 130 via the system interface bus 140 at a desired timing.

### Related Art

Japanese Laid-open Patent Publication No. Sho 61-084767

In recent year, it has progressed that the LSI (semiconductor integrated circuit) are highly integrated. Therefore, functions which built in the LSI are increased, and package pins for interface of the LSI (semiconductor integrated circuit) are increased. In the design of the LSI (semiconductor integrated circuit) in future, it is necessary to continue the efforts to reduce the number of interfaces described above.

In FIG. 15, the system management device 100 performs an initialization of all of the LSI. Therefore, it is necessary that the each LSI (a semiconductor integrated circuit device) has an interface with the system management device 140. In general, at least two or more interfaces are required. For example, I2C (Inter-Integrated Circuit) bus which is often used as the system interface is defined two signal lines of serial data (SDA) and serial clock (SCL).

Therefore, it is necessary to provide at least two package pins to the LSI as the interface. In addition, there is a need for system management device. As a result, the design of the LSI effort is increased, and also the design cost is increased. In addition, there is also a problem, such as the complexity of system design.

### SUMMARY

According to an aspect of the embodiments, an electronic system includes a plurality of semiconductor integrated circuit devices that are connected by a signal line one to each other and has a functional circuit which performs a predetermined function by setting data which has been set, a storage unit which stores the setting data of each of the semiconductor integrated circuit device. And one semiconductor integrated circuit device of the plurality of semiconductor integrated circuit devices includes an initialization control circuit which sequentially reads the setting data of each of the plurality of the semiconductor integrated circuit devices from the storage unit, sets the setting data of the one semiconductor integrated circuit device to the functional circuit of the one semiconductor integrated circuit device, and transfers the setting data of other semiconductor integrated circuit device to the other semiconductor integrated circuit via the signal line.

According to another aspect of the embodiments, a semiconductor integrated circuit device includes a functional circuit which performs a predetermined function by setting data which has been set, and an initialization control circuit which sequentially reads the setting data of each of a plurality of the semiconductor integrated circuit devices from the storage unit which stores the setting data of each of the semiconductor integrated circuit device, sets the setting data of the semiconductor integrated circuit device to the functional circuit of the semiconductor integrated circuit device, and transfers the setting data of other semiconductor integrated circuit device to the other semiconductor integrated circuit via a signal line.

The object and advantages of the invention will be realized and attained by means of the elements and combinations part particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of an electronic system according to an embodiment;

FIG. 2 is a detailed block diagram of the electronic system in FIG. 1;

FIG. 3 is an explanatory diagram of setting data in a non-volatile memory in FIG. 1 and FIG. 2;

FIG. 4 is an explanatory diagram of signal lines in FIG. 1 and FIG. 2;

FIG. 5 is an explanatory diagram of a register in a master LSI in FIG. 1 and FIG. 2;

FIG. 6 is an explanatory diagram of a register in a slave LSI in FIG. 1 and FIG. 2;

FIG. 7 is an explanatory diagram of a highest control byte in FIG. 5 and FIG. 6;

FIG. 8 is an explanatory diagram of a lowest control byte in FIG. 5 and FIG. 6;

FIG. 9 is a time chart of the operation of the master LSI in FIG. 2;

FIG. 10 is a time chart of the operation of the master LSI and slave LSI in FIG. 2;

FIG. 11 is a process flow diagram of register initialization in the master LSI in FIG. 1 and FIG. 2;

FIG. 12 is a process flow diagram of register initialization in the slave LSI in FIG. 1 and FIG. 2;

FIG. 13 is an explanatory diagram of the set time of the initialization process according to the embodiment;

FIG. 14 is a block diagram of the electronic system according to another embodiment; and

FIG. 15 is an explanatory diagram of a conventional initialization process of registers.

### DESCRIPTION OF EMBODIMENTS

Hereinafter, the embodiments will be explained in the order of the embodiment of the electronic system, a composition of a semiconductor integrated circuit, an initialization circuit, processing of initial setting of register, another embodiment of an electronic system, and other embodiments. However, the electronic system and the semiconductor integrated circuit device are not limited to the embodiment.

(Embodiment of an Electronic System)

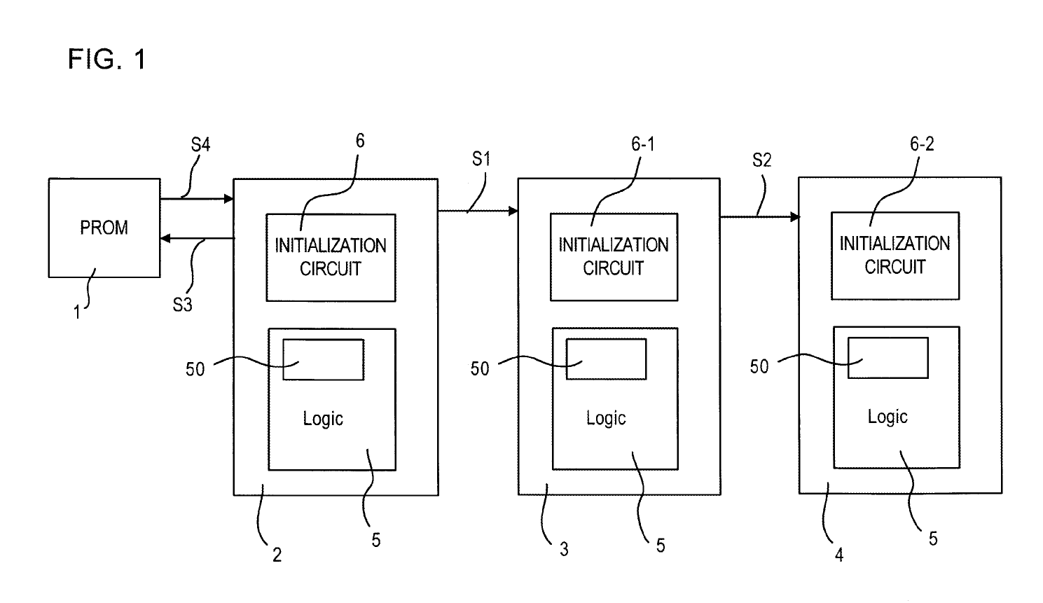

FIG. 1 is a block diagram of an electronic system equipped with a LSI according to the embodiment. As illustrated in FIG. 1, the electronic system includes a nonvolatile memory 1 and a plurality of LSI 2, 3 and 4. The nonvolatile memory 1 stores setting values of registers. It is desirable that the nonvolatile memory 1 is configured of PROM (Programable Read Only Memory), for example. The PROM is a device which is a kind of ROM and has been written the data in advance by user. The non-volatile memory 1 holds the setting values (initial register values) for each of the LSI 2, 3 and 4.

The LSI 2, 3 and 4 are LSI (semiconductor integrated circuit device) which is necessary to set an initial value of the register. The LSI 2 connects to the nonvolatile memory 1 via signal lines S3 and S4. The LSI 2 reads the set values from the nonvolatile memory 1. The LSI 2 is called to a master LSI 2, because the LSI 2 reads the set values from the nonvolatile memory 1.

The master LSI 2 includes a functional circuit 5 which performs an original control and an initialization circuit 6. The functional circuit 5 has a register 50 for setting and has control logic of a control function of the LSI 2. The initialization circuit 6 has control logic which controls a necessary operation to set up the initialization of register 50. The master LSI 2 includes an input and output (I/O) module (not illustrated in FIG. 1) to communicate with other LSIs.

The master LSI 2 connects to the LSI 3 via a signal line S1. Also, the LSI 3 connects to the LSI 4 via a signal line S2. The LSI 3 receives data from the master LSI 2 via the signal line S1. The LSI 4 receives the data from the LSI 3 via the signal line S2. Therefore the subsequent LSI (semiconductor integrated circuit device) 3 and 4 are referred to as a slave LSI.

Each of the slave LSI 3 and 4 includes a functional circuit 5 which performs an original control and an initialization circuit 6-1, 6-2. The functional circuit 5 has a register 50 for setting and has control logic of a control function of the LSI 3 and 4. Each of the initialization circuit 6-1 and 6-2 has control logic which controls a necessary operation to set up the initialization of register 50. Each of the slave LSI 3 and 4 includes an input and output (I/O) module (not illustrated in FIG. 1) to communicate with other LSIs.

In other words, the master LSI 2 connects to the nonvolatile memory 1, and the slave LSI 3 and 4 are connected to the master LSI 2 in a string. In the embodiment, two slave LSIs are provided, the number of the slave LSI may be provided with one or three or more.

The initialization circuit 6 of the master LSI 2 reads the setting data (setting values in the master LSI 2 and the slave LSI 3, 4) in the nonvolatile memory 1 by using the signal lines S3, S4. The initialization circuit 6 of the master LSI 2 sets the setting data of the master LSI 2 that has been read to the register 50 in the functional circuit 5. And the initialization circuit 6 of the master LSI 2 transfers the setting data of the LSI 3 and 4 which was read to the slave LSI 3 through the signal line S1.

The initialization circuit 6-1 in the slave LSI 3 sets the setting data of the slave LSI 3 that has been received to the register 50 in the functional circuit 5. And the initialization circuit 6-1 of the slave LSI 3 transfers the setting data of the slave LSI 4 which has been received to the slave LSI 4 through the signal line S2. Then, the initialization circuit 6-2 in the slave LSI 4 sets the setting data of the slave LSI 4 which has been received to the register 50 in the functional circuit 5.

In this way, in a system having a plurality of LSI (semiconductor integrated circuit device), for the plurality of LSI (semiconductor integrated circuit device) which are connected in a string, the initial setting of the register are performed in sequence one by one through a single line. As will be described later, a dedicated signal line to perform the initial setup, or a signal line, such as side-band to be used for exchange of information and data between the LSI during normal operation is utilized as the signal line. When the operation is performed using a sideband signal line, it is not necessary to provide a special interface for the register initialization.

For this reason, it is possible to reduce the number of interfaces of the LSI 2, 3 and 4. In particular, it is possible to reduce the number of package pins of the LSI to be used in the interface. Furthermore, since the system management device is not required to initialize the registers, the complexity of system design can be avoided. Therefore, it is possible to prevent an increase in design cost and an increase of design man-hours of the LSI.

(Composition of a Semiconductor Integrated Circuit)

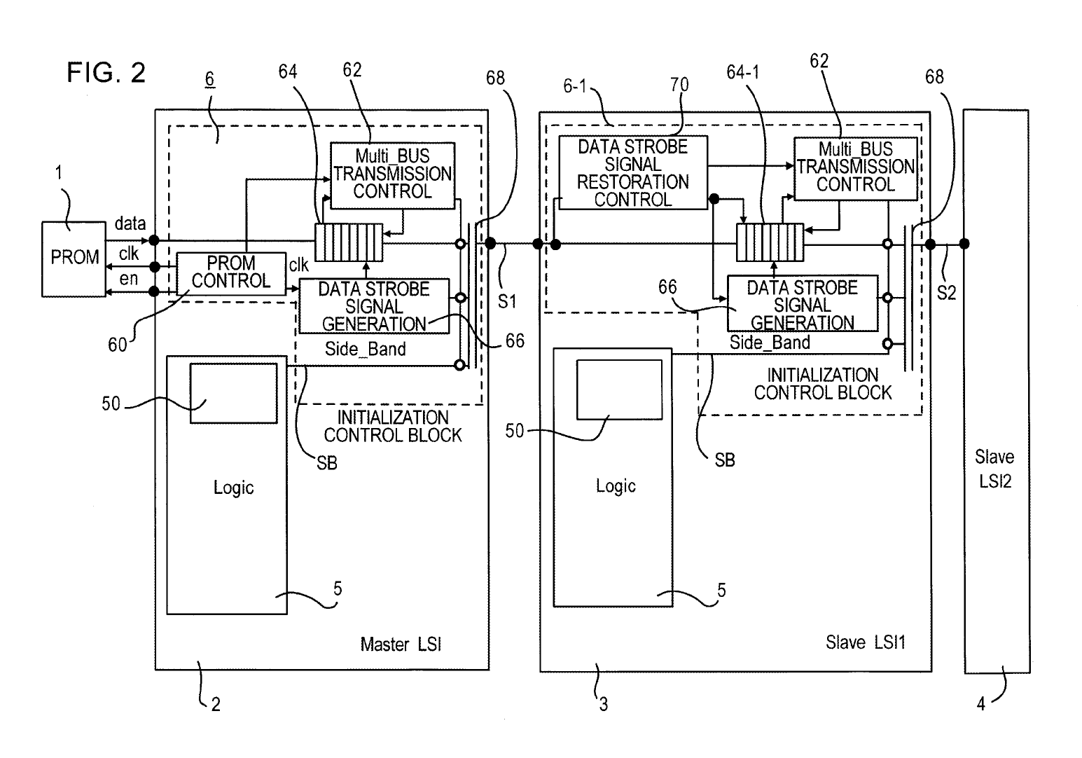

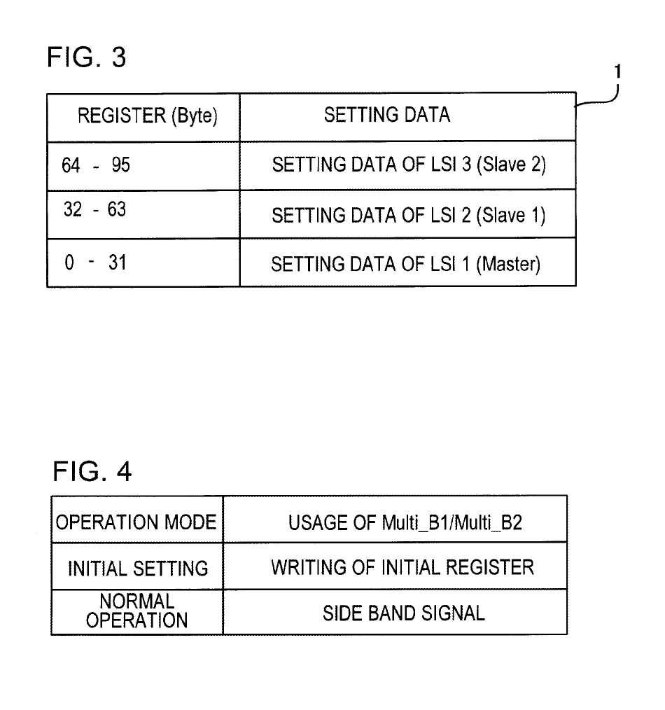

FIG. 2 is a detailed block diagram of the composition of FIG. 1. FIG. 3 is an explanatory diagram of the data stored in the nonvolatile memory in FIG. 1 and FIG. 2. FIG. 4 is an explanatory diagram of signal lines in FIG. 1 and FIG. 2.

As depicted by FIG. 2, the master LSI 2 includes the initialization circuit 6 and the functional circuit 5. And the initialization circuit 6 has a memory (PROM) control circuit 60, a shift register 64, a multi-bus control circuit 62, a data strobe signal generating circuit 66, and a selector 68.

The memory control circuit (hereinafter, referred to as PROM control circuit) 60 is a module for controlling the operation of the memory (PROM) 1. After power is applied to the master LSI2, the PROM control circuit 60 starts to access to the memory (PROM) 1 after a predetermined time to stabilize the operation.

For example, the PROM control circuit 60 makes an enable signal (referred to as “en” in FIG. 2) to “1” (High), and generates a readout clock “clk”. For example, the PROM control circuit 60 automatically generates the read clock “clk” by using a reference clock of 25 MHz. The PROM control circuit 60 sends generated the read clock to the memory (PROM) 1 through the clock signal line “clk”.

FIG. 3 illustrates an example of data storage in the memory (PROM) 1. As depicted by FIG. 3, the register setting values of 32 byte are defined to the registers 50 of each of the LSI (semiconductor integrated circuit device) 2, 3 and 4, for example. The memory 1 stores the setting data in the register of the master LSI 2 in lower 32 byte (0-31 Byte), stores the setting data in the register of the slave LSI 3 in middle 32 byte (32-63 Byte), and stores the setting data in the register of the slave LSI 4 in upper 32 byte (64-95 Byte).

That is, the memory has the setting data of 768 [bit]=32 [byte]×3 [chip]=96 [byte].

Returning to FIG. 2, the PROM control circuit 60 reads the data from the lower bits of the memory (PROM) 1 by the clock “clk”. The data which is read from the memory (PROM) 1 is sent to the initialization circuit 6 through the interface between the LSI (data line as described “data” in FIG. 2).

The shift register 64 stores the data that has been read. In the embodiment, the shift register 64 has a length of 32 Byte. The shift register 64 holds and shifts the initial setting data of the register in the LSI (semiconductor integrated circuit device).

The data strobe signal generating circuit 66 generates a data strobe signal for writing of the shift register 64. The data strobe signal generating circuit 66 generates the data strobe signal for the shift register 64 from generated clock (read clock) “clk” from the PROM control circuit 60. For example, the data strobe signal is a rising edge of the clock “clk” to the memory (PROM) 1. This specification may be implemented according to the memory (PROM) used.

The multi-bus transmission control circuit 62 receives a signal of read operation from the PROM control circuit 60, and determines whether or not the setting data are collected in the shift register 64, whether or not the collected data in the shift register 64 is the setting data of the master LSI 2, and whether or not the collected data in the shift register 64 is the setting data of the slave LSI 3 and 4.

The multi-bus transmission control circuit 62 writes the setting data in the shift register 64 into the register 50 in the functional circuit 5 of the master LSI 2, when it is determined that the setting data are collected in the shift register 64 and the collected data in the shift register 64 is the setting data of the master LSI 2.

The multi-bus transmission control circuit 62 switches the selector 68 to output the slave LSI 3 when it is determined that the collected data in the shift register 64 is not the setting data of the master LSI 2.

The selector 68 selects one output of the three data. A first output is the data stored in the shift register 64. A second output is the data strobe signal which is generated by adjusting the clock generated from the PROM control circuit 62 by the data strobe signal generating circuit. A third output is a sideband signal from the functional circuit 5 during normal operation. The multi-bus transmission control circuit 62, as described below, performs a selection control of these signals, and selects output data to the signal line S1.

In the embodiment, a sideband signal line is used as the signal line S1. For example, as the side-band signal line, it is possible to use a point-to-point signal line for an interrupt signal or a request signal between the various chips. In order to reduce signals between the LSI through the bus signal lines, a sideband signal line is provided separately from the bus signal lines.

In the embodiment, since the functional circuit 5 does not use the sideband signal line when the initial setting, the sideband signal line is used for the data transfer of initial setting during the initial setup. FIG. 4 is a diagram illustrating the correspondence between operating modes and usage of the signal lines S1 and S2. When the operation mode indicates the initial setting, the signal lines S1 and S2 are used for the initial write of the register. When the operation mode indicates a normal operation, the signal lines S1 and S2 are used for the sideband signal.

The multi-bus transmission control circuit 62 controls the selector 68 to select the output of the shift register 64 or the data strobe signal generating circuit 66, at the time of initial setting. In addition, the multi-bus transmission control circuit 62 controls the selector 68 to select the sideband signal from the functional circuit 5, after the initial setting is finished. In the embodiment, since the sideband signal line which utilizes during a normal operation is used as a write path for the register when initial setting of the register, it is not necessary to provide a dedicated signal line for the initial register settings.

Returning to FIG. 2, the slave LSI 3 includes an initialization circuit 6-1 and a functional circuit 5. The initialization circuit 6-1 has a data strobe signal restoration control circuit 70, a shift register 64-1, a multi-bus transmission control circuit 62, a data strobe signal generating circuit 66, and a selector 68.

The data strobe signal restoration circuit 70 detects a data strobe signal from the signal from the signal line S1, and starts the data strobe signal generating circuit 66. The shift register 64-1 stores the data inputted from the signal line S1. In the embodiment, the shift register 64-1 has a length of 32 Byte. The shift register 64-1 holds and shifts the initial setting data of the register in the slave LSI 3 (semiconductor integrated circuit device).

The data strobe signal generating circuit 66 generates a data strobe signal for writing of the shift register 64-1. The data strobe signal generating circuit 66 generates the data strobe signal for the shift register 64-1 from internal clocks. As described below, the data strobe signal of the slave LSI is a signal which is shifted the phase 90 degree from the data strobe signal from the master LSI 2.

The multi-bus transmission control circuit 62 receives a signal of read operation from the data strobe restoration control circuit 70, and determines whether or not the setting data are collected in the shift register 64-1, whether or not the collected data in the shift register 64-1 is the setting data of the slave LSI 3, and whether or not the collected data in the shift register 64-1 is the setting data of the slave LSI 4.

The multi-bus transmission control circuit 62 writes the setting data in the shift register 64-1 into the register 50 in the functional circuit 5 of the slave LSI 3, when it is determined that the setting data are collected in the shift register 64-1 and the collected data in the shift register 64-1 is the setting data of the slave LSI 3.

The multi-bus transmission control circuit 62 switches the selector 68 to output to the slave LSI 4 when it is determined that the collected data in the shift register 64-1 is not the setting data of the slave LSI 3.

The selector 68 performs same operation as that of the selector 68 in the master LSI 2. That is, the selector 68 selects one output of the three data. A first output is the data stored in the shift register 64-1. A second output is the data strobe signal which is generated by adjusting by the data strobe signal generating circuit 66. A third output is a sideband signal from the functional circuit 5 during normal operation. The multi-bus transmission control circuit 62, as described below, performs a selection control of these signals, and selects output data to the signal line S2.

The slave LSI 4 is the same configuration as the slave LSI 3. Thus, the slave LSI 3 and 4 have the nearly same composition as that of the master LSI 2. The difference from the master LSI 2 is that the slave LSI 3 and 4 have not the PROM control circuit, because the slave LSI 3 and 4 do not directly read out data from the memory (PROM). Therefore, the slave LSI 3 and 4 have the data strobe restoration control circuit 70 in order to receive the data from the master LSI 2 or the slave LSI 3 via the signal lines S1 or S2.

(Initialization Circuit)

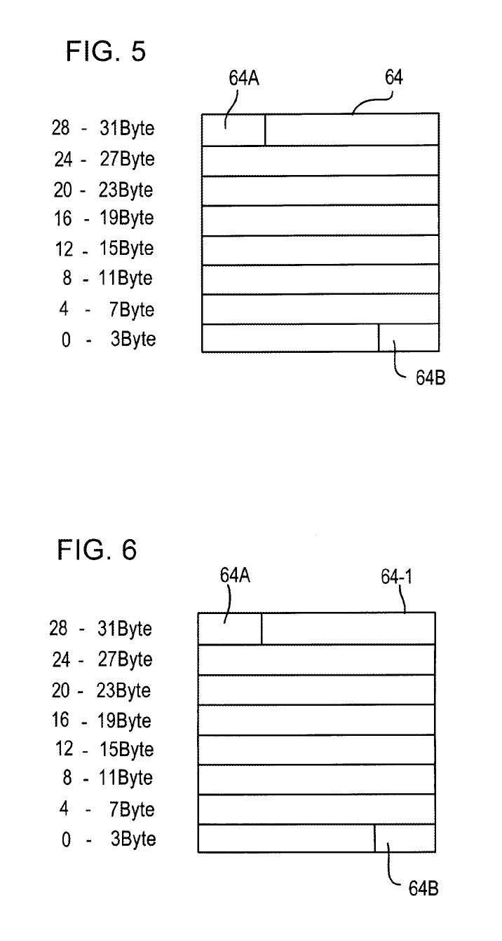

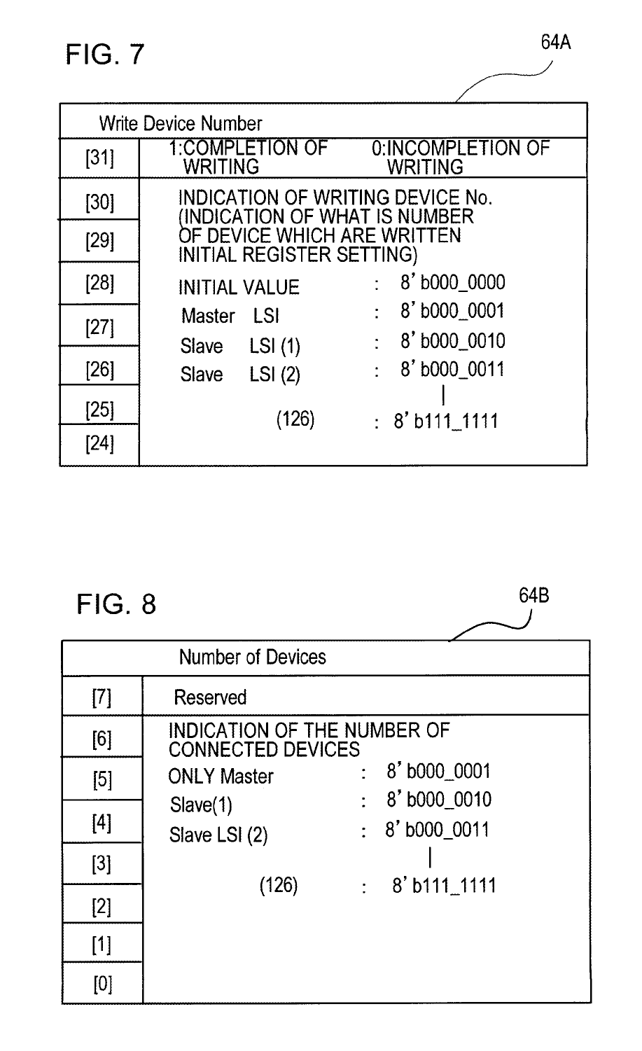

Next, the multi-bus transmission control circuit 62 will be explained. FIG. 5 is an explanatory diagram of the data configuration in the shift register of the master LSI 2 in FIG. 2. FIG. 6 is an explanatory diagram of the data configuration in the shift register of the slave LSI in FIG. 2. FIG. 7 is an explanatory diagram of the most significant (top) byte in FIG. 5 and FIG. 6. FIG. 8 is an explanatory diagram of the least significant (lowest) byte in FIG. 5 and FIG. 6. In addition, in FIG. 5 to FIG. 8, the example that each LSI 2, 3 and 4 have the shift register 64, 64-1, and the register 50 of 32 bytes will be explained.

As depicted by FIG. 5, the shift register 64 (register 50) is constructed of a 32-byte register from the most significant byte 64A until the least significant byte 64B. As depicted by FIG. 6, the shift register 64-1 (or the register 50) is constructed of a 32-byte register from the most significant byte 64A until the least significant byte 64B.

As depicted by FIG. 7, the most significant byte 64A in FIG. 5 and FIG. 6 stores a write control and a transfer control data to initialize the registers. In the embodiment, since the fourth byte of the most significant byte is defined, the specification of the bits [31:24] (fourth byte) will be explained. The most significant byte 64A indicates a position (number) of the device (LSI) which is written the data held in the shift registers 64, 64-1 and is referred to as the “Write Device Number”.

The bit [31] indicates whether or not the multi-bus transmission control circuit 62 of the initialization circuit completes the writing of the data held in the shift register 64 or 64-1 into the register 50 of the functional circuit 5 in the LSI having the initialization circuit. In the bit [31], (“1”) indicates the completion of the writing and (“0”) indicates incomplete of the writing. The bits [30:24] indicate a write device position. For example, in order to write the setting data to the master LSI2, the Write Device Number [31:24] is set to “8′ b1000_{—}0001”. In addition, in order to write the setting data to the slave LSI 3, 4, the Write Device Number [31:24] are set to “8′ b1000_{—}0010”, “8′ b1000_{—}0011”, respectively.

As depicted by FIG. 8, the least significant byte 64B indicates the number of the device (LSI) that performs initialization of the register, and is referred to “Number of Devices”. The bit [7] is a spare bit. The bits [6:0] indicate the number of devices to be connected. Since the 7-bits are assigned to the number of devices, the slave LSI can be represented up to 126 devices. For example, when the connection device is only the master LSI, the Number of Devices [7:0] are set to “8′ b0000_{—}0001”. When the slave LSI is one device, the Number of Devices [7:0] are set to the “8′ b0000_{—}0010”.

The multi-bus transmission control circuit 62 determines the number of device to be connected and whether the received data is a setting data of own LSI or a setting data of subsequent LSI from the most significant byte 64A and one byte of the least significant byte 64B top in the received data set of 32 bytes, and fetches or transfers the data held in the shift registers 64, 64-1.

For example, when the master LSI 2 received following most significant byte 64A and the least significant byte 64B from the memory 1, the master LSI 2 determines as follows.

In a case of received least significant byte 64B (Number of Devices [7:0]) =“8′ b0000_{—}0011”, and the most significant byte 64A (Write Device Number [31:24])=“8′ b1000_{—}0001”, the multi-bus transmission control circuit 62 in the master LSI 2 determines that the subsequent two LSI (a semiconductor integrated circuit device) are present according to the reception of the data. Thereby, the multi-bus transmission control circuit 62 in the master LSI 2 forwards two set of the received data subsequent to the setting data of the LSI 2 itself to the subsequent LSI.

Further, when the slave LSI 3 received following the most significant byte 64A and the least significant byte 64B from the master LSI 2, the slave LSI 3 determines as follows.

In a case of reception of the least significant byte 64B (Number of Devices [7:0])=“8′ b0000_{—}0011”, and the most significant byte 64A (Write Device Number [31:24])=“8′ b1000_{—}0010”, the multi-bus transmission control circuit 62 of the slave LSI 3 determines that one subsequent LSI (a semiconductor integrated circuit device) is present. Thereby, the multi-bus transmission control circuit 62 in the slave LSI 3 forwards one set of the received data subsequent to the setting data of the LSI 3 itself to the subsequent LSI.

Furthermore, when the multi-bus transmission control circuit 62 in the slave LSI 3 received following the most significant byte 64A and the least significant byte 64B from the master LSI 2, the multi-bus transmission control circuit 62 in the slave LSI 3 determines as follows.

In a case of reception of the least significant byte 64B (Number of Devices [7:0])=“8′ b0000_{—}0011” and the most significant byte 64A (Write Device Number [31:24])=“8′ b1000_{—}0011”, the multi-bus transmission control circuit 62 of the slave LSI 3 determines that no subsequent LSI (a semiconductor integrated circuit device) is present according to the reception of above data. That is, the multi-bus transmission control circuit 62 determines that the device itself is a last device.

Further, the present embodiment is described as an example that one LSI chip had the initialization register 50 of 256 bits fixed length, but the case that one LSI chip has a plurality of initial register may be applied. In this case, the number of registers is set as the register set value as same as the number of the slave LSI, and a plurality of the initial register are performed the setting.

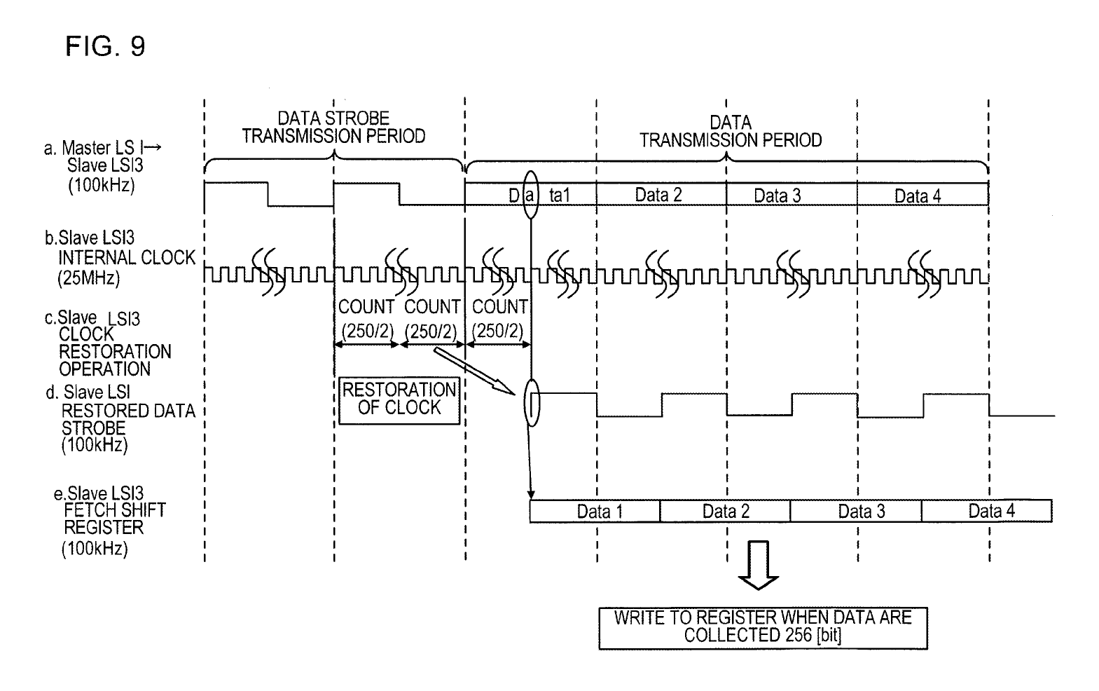

Next, the operation of restoring the data strobe will be explained. FIG. 9 is a time chart of the writing process of the slave LSI. In FIG. 9, the symbol “a”˜“e” represent the operation of the data going from the master LSI 2 to the slave LSI 3. First, “a. Master LSI 2→slave LSI 3 indicates transmission status between the master LSI 2 and the slave LSI 3 via the signal line S1. The data strobe signal generating circuit 66 of the master LSI 2 outputs the two data strobe signals to the signal line S1 via the selector 68.

The data strobe restoration control circuit 70 of the slave LSI 3 detects alternating with “High” and “Low” for a predetermined period of time in the signal line S1 according to the internal clock (25 MHz) of the slave LSI 3 as indicates as “b”. For example, the predetermined period of time is more than 50 cycles of the 25 MHz clock. When the data strobe restoration control circuit 70 detects that the signal from the signal line S1 repeats the “High” and “Low” for a period of more than 50 cycle, the data strobe restoration control circuit 70 counts a rise (High) periods of second data strobes which is continuously received.

The data strobe restoration control circuit 70 determines the count values less than the number of 50 cycles as the noise, and resets itself. When the slave LSI 3 receives the data strobe signal of 100 KHz cycle from the master LSI 2, following number of cycles are counted by counting the clock of 25 MHz.

Rise (High) periods=250/2=125 [cycle]

Fall (Low) periods=250/2=125 [cycle]

Based on this count value, the data strobe restoration control circuit 70 regenerate the data strobe signal having a 50% duty cycle. Then, the data strobe restoration control circuit 70 creates a restored data strobe signal for fetching of data which was delayed the regenerated data strobe signal by 90° (125 [cycle]) (as described as “d. restore data strobe). The “d. Restore data strobe in Slave LSI 3 in FIG. 9” indicates the data strobe signal of 100 KHz.

In the embodiment, the example is described that the rising and falling of the signal of the data strobe are same cycle, but it is also possible to employ the average value of both periods and it is not necessary that the duty ratio always is 50%, when the number of cycles is different each other.

On the other hand, the multi-bus transmission control circuit 62 in the master LSI 2, after operating the selector 68 and dispatching own data strobe signal in two times, sends the data in the shift register 64 by updating the data in the shift register 64 at the timing of the rising edge of the transmission data strobe. The slave LSI 3 receives the data at the rising edge of the restoration data strobe which was restored in advance.

That is, the shift register 64-1 of the slave LSI 3 captures the received data at the rising edge of the restoration data strobe signal. A symbol “e” in FIG. 9 represents an operation in which the data is written to the shift register 64-1 of the slave LSI 3. The multi-bus transmission control circuit 62 detects that the shift register 64-1 held (collected) data of 256 bit (32 byte), and writes (captures) the data held in the shift register 64-1 to the register 50 of the functional circuit 5. By this operation, the slave LSI 3 receives the data from the master LSI 2 in a single signal line, and initially sets the data in the register 50.

In addition, a similar control is performed during the transfer of the initial register values between the slave LSI. That is, in FIG. 9, by replacing the master LSI 2 to the slave LSI 3 and the slave LSI 3 to the slave LSI 4, the restoration of data strobe and the capturing of the data are performed.

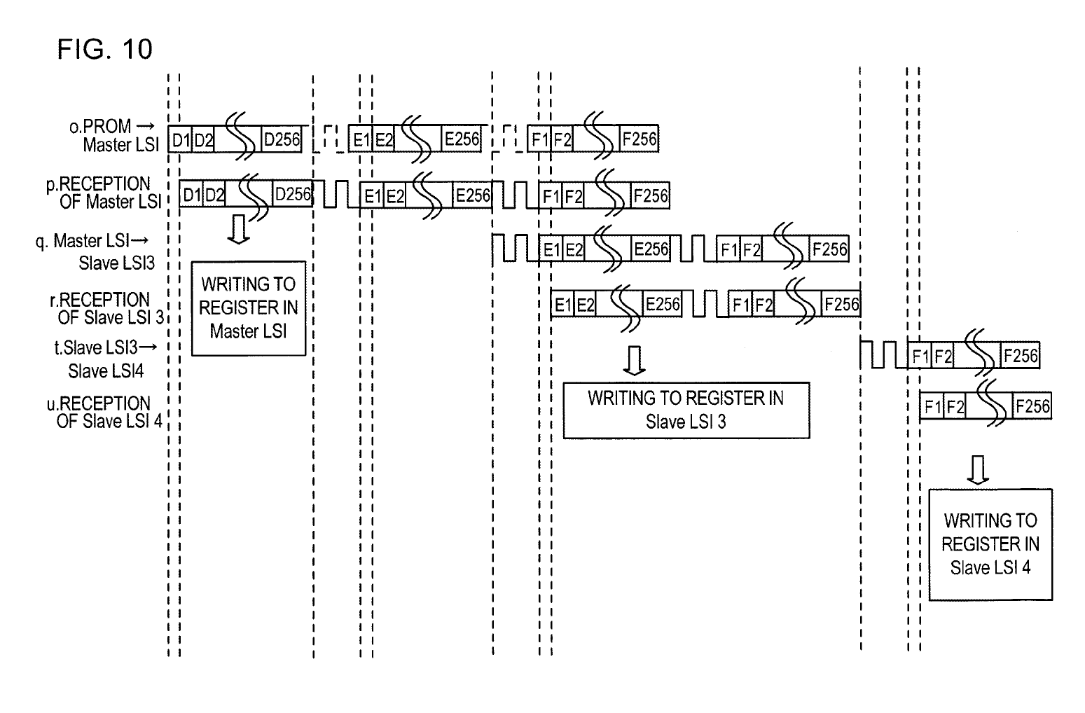

FIG. 10 is a time chart of data transmission from the master LSI 2 to the slave LSI 3 and 4 according to the present embodiment. FIG. 10 illustrates the operation of transmission of the set value of the register from the master LSI 2 to the slave LSI 3 and the operation of transmission of the set value of the register from the slave LSI 3 to the slave LSI 4.

In FIG. 10, a symbol “o” indicates the status of the transmission path which outputs the data read from the memory (PROM) 1 to the master LSI 2. First, the data of 256 bits to be set in the master LSI2 is read. As described above, the master LSI 2 captures own register setting values into the own register 50. The master LSI 2 , after the capturing, again read the data of 256 bits from the memory 1 after waiting for the data strobe signal of two cycles. The value read from memory 1 for the second time is a set value of the register for the slave LSI 3.

Such a reading and transfer operation is repeated in the number of the LSI 2, 3 and 4 which is mounted on the system. As described in FIG. 5 to FIG. 8, because each LSI itself grasps the number of the LSIs in the system and data that the own LSI is what number of the LSIs to be set through the register, a read and a transfer operation is possible.

A symbol “p” reception of Masters LSI 2″ in FIG. 10 indicates an operation that the master LSI 2 receives the initial data of the register. Because the data of the memory (PROM) 1 are outputted in synchronization with the data strobe signal together, the master LSI 2 receives data at a timing which is delayed phase 90 ° of the data strobe signal output for the control of the memory (PROM) 1.

Next, the slave LSI will be explained. A symbol “q” indicates the transfer from the master LSI 2 to the slave LSI 3. As described above, the master LSI 2 transfers the data after the setting data of the registers for its own use to the slave LSI 3. The slave LSI 3 restores the data strobe previously mentioned, and captures the data from the master LSI 2. A symbol “r. Reception of Slave LSI 3” in FIG. 10, indicates a capture operation of the data by the restored strobe.

Finally, in FIG. 10, a symbol “t. Slave LSI 3→Slave LSI 4” and a symbol “u. Reception of Slave LSI 4” indicate the operation of the slave LSI 4. The slave LSI 4 performs the same operation as the slave LSI 3. However, in the embodiment, since the slave LSI 4 is a final LSI (semiconductor integrated circuit device) to set the register, the slave LSI 4 captures its own register set value, and terminates the operation of initialization.

(Processing of Register Initialization)

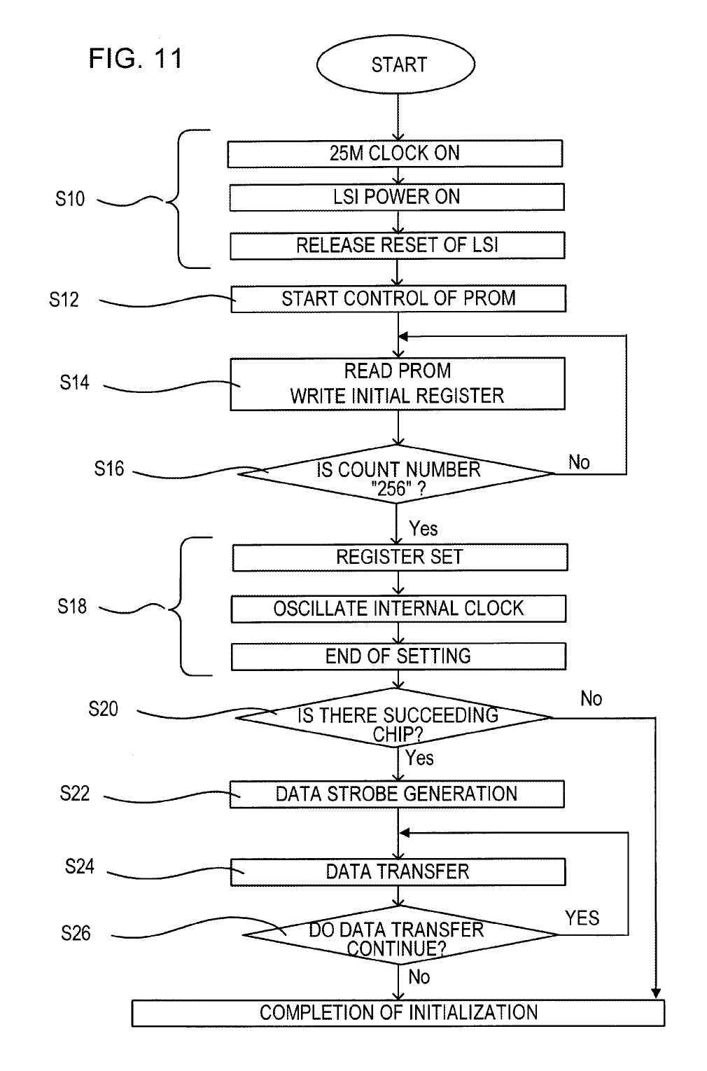

FIG. 11 is a flow diagram of the initialization of the register setting in which the master LSI2 performs.

(S10) The reference clock (clock of 25 MHz) to be supplied to the master LSI2 is turned on. Then, the power of the master LSI 2 is turned on. In addition, the reset of the master LSI 2 is released. Thus, the master LSI 2 starts its operation.

(S12) The PROM read circuit 60 in the master LSI 2 operates autonomously. In other words, the master LSI 2 starts the PROM control circuit 60.

(S14) The started PROM control circuit 60 reads the initial register setting value stored in the memory (PROM) 1 and captures the data into the shift register 64 of own device.

(S16) The multi-bus transmission control circuit 62 in the master LSI 2 determines whether the setting data of the 256-bit, of which is necessary data length, is read into the shift register 64.

(S18) When the multi-bus transmission control circuit 62 determines that the initial register setting value was read into the shift register 64, the multi-bus transmission control circuit 62 captures the set value of the register in the shift register 64 into the register 50 in the functional circuit 5. The functional circuit 5 in the master LSI 2, after capturing the initial register setting value, causes the internal clock in the master LSI 2 to oscillate triggered by setting these values. Thus, the initial setting of the master LSI 2 is completed.

(S20) The multi-bus transmission control circuit 62 in the master LSI 2, after the initial setting of its own was completed, determines whether there is a subsequent LSI (chip). When the multi-bus transmission control circuit 62 determines that the subsequent LSI (chip) is not present, the multi-bus transmission control circuit 62 sets the output path to the Side-Band signal and terminates the setting process.

(S22) When the multi-bus transmission control circuit 62 determines that the subsequent LSI (chip) is present, the multi-bus transmission control circuit 62 transfers the data strobe signal to restore to the slave LSI 3 through the signal line 51.

(S24) The multi-bus transmission control circuit 62 transfers the data held in the shift register 64 to the slave LSI 3 via the signal line 51 subsequent to this operation. For the data strobe signal and the data transfer is the same as that described with reference to FIG. 9. That is, in order that the master LSI 2 performs the operation as depicted by FIG. 9 during the data transfer, the master LSI2 reads the data from the memory (PROM) 1 and transmits the data (initial register setting value) to be transferred to the slave LSI3.

(S26) Because the transfer data is determined by the number of slave LSI, the master LSI 2 repeats by the number of slave LSI, and continues to operate. The data transfer mechanism is as described in FIG. 10. When the master LSI 2 completes all data transfer, the master LSI 2 ends the initialization settings. Then, the multi-bus transmission control circuit 62 sets a selection output of the selector 68 to the Side-Band signal.

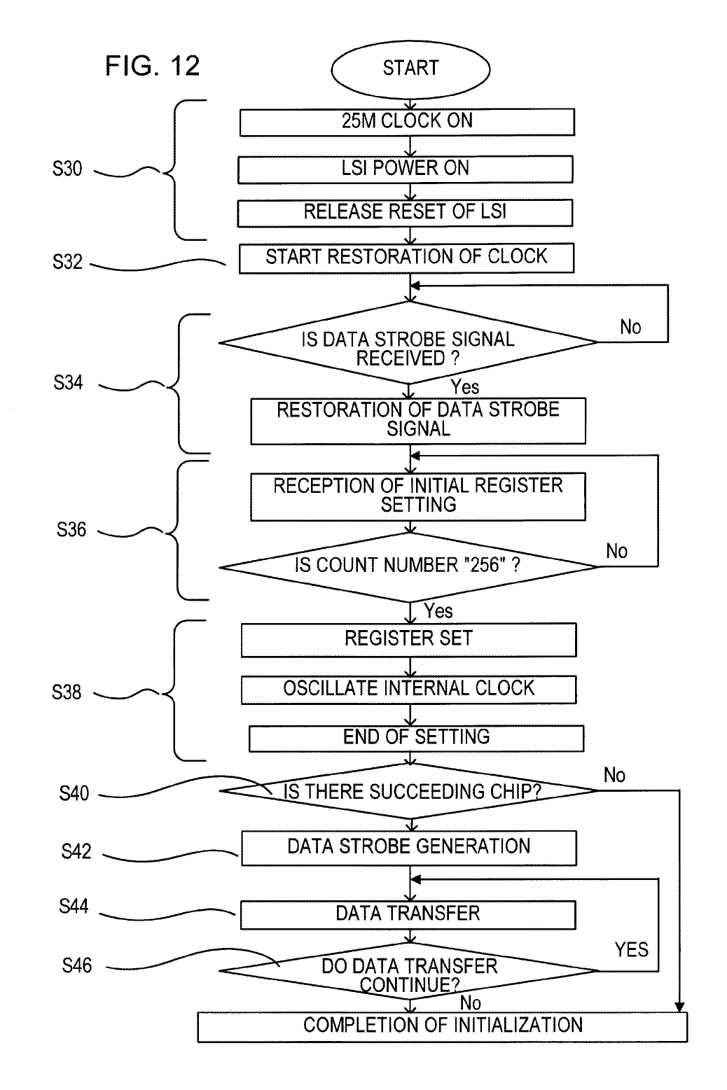

FIG. 12 is a flow diagram of the initialization of the register setting value performed by the slave LSI.

(S30) The slave LSI 3 and 4 performs the same operation of the master LSI 2 as step S10.

(S32) In the slave LSI 3 and 4, the data strobe restoration control circuit 70 starts autonomously. Thus, the slave LSI becomes a state to detect the data strobe signal from the master LSI 2 or Slave LSI 3.

(S34) The data strobe restoration control circuit 70 in the slave LSI, when detecting the strobe signal from the master LSI 2 or Slave LSI 3, restores the data strobe signal.

(S36) The shift register 64-1 in the slave LSI captures the data input from the signal line S1 or S2 by the restored data strobe signal. The multi-bus transmission control circuit 62 in the slave LSI 3 and 4 determines whether the shift register 64-1 reads the set value of 256 bits which is necessary data length.

(S38) When the multi-bus transmission control circuit 62 determines that the initial register setting value was read into the shift register 64-1, the multi-bus transmission control circuit 62 captures the set value of the register in the shift register 64-1 into the register 50 in the functional circuit 5. The functional circuit 5 in the slave LSI 3 and 4, after capturing the initial register setting value, causes the internal clock in the slave LSI 3 and 4 to oscillate data strobe signal trigged by setting these values. Thus, the initial setting of the slave LSI 3 and 4 are completed.

(S40) The multi-bus transmission control circuit 62 in the slave LSI 3 and 4, after the initial setting of its own was completed, determines whether there is a subsequent LSI (chip). When the multi-bus transmission control circuit 62 determines that the subsequent LSI (chip) is not present, the multi-bus transmission control circuit 62 sets the output path to the Side-Band signal and terminates the setting process.

(S42) When the multi-bus transmission control circuit 62 determines that the subsequent LSI (chip) is present, the multi-bus transmission control circuit 62 transfers the data strobe signal to restore to the slave LSI 4 through the signal line S2.

(S44) The multi-bus transmission control circuit 62 transfers the data held in the shift register 64-1 to the slave LSI 4 via the signal line S2 subsequent to this operation.

(S46) Because the transfer data is determined by the number of slave LSI, the slave LSI 3 repeats by the number of the other slave LSI, and continues to operate. When the slave LSI 3 ends the initialization settings, the multi-bus transmission control circuit 62 sets a selection output of the selector 68 to the Side-Band signal.

By the above operation, the initial register settings of the master LSI 2 and the slave LSI 3 and 4 are executed.

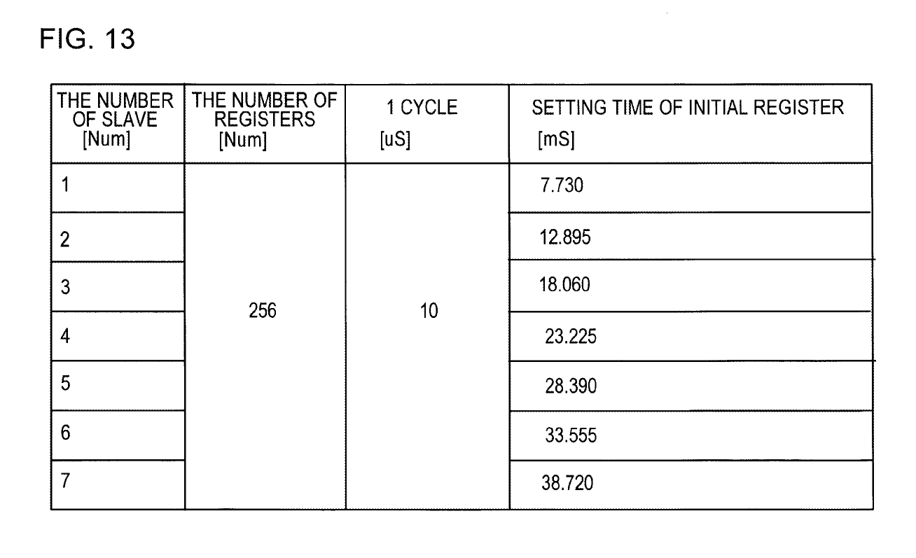

FIG. 13 is an explanatory diagram of the initial setup time of the register according to the embodiment. FIG. 13 illustrates a table of correspondence the number of slave with the setting time of the initial register (m sec: millisecond) when the number of registers (that is, the number of bits in the register) “R” is given to 256 bits and the on cycle time is given to 10 μsec. And when “N” is the number of slaves, the initial register time “S” is given by the following equation.

Initial register setting time (t) [S]={(2R+2+1/2)+(R+2+1/2)·N+(R+2)(N−1)}·T(N>0)

FIG. 13 depicts the setting time of the initial register when the number of slaves N is changed to “1” to “7”. As illustrated in FIG. 13, the setting is completed in several tens of m sec even though the number of slaves is large (for example, the number of slaves is 7). Further, the example in FIG. 13 represents only the time to set the initial register and not includes the operation time such as the time to turn on the power required for initializing and the time to release the reset of the LSI (semiconductor integrated circuit device).

(Another Embodiment of the Electronic System)

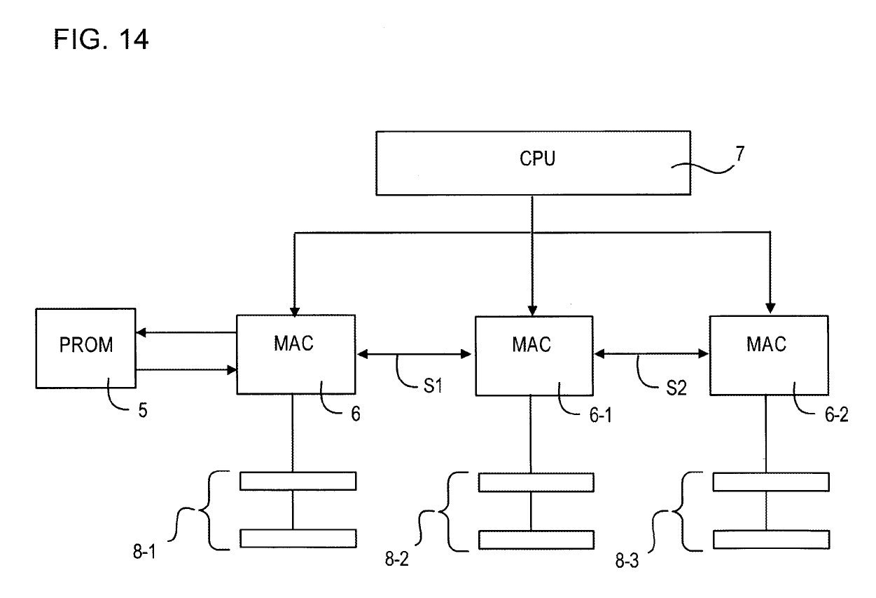

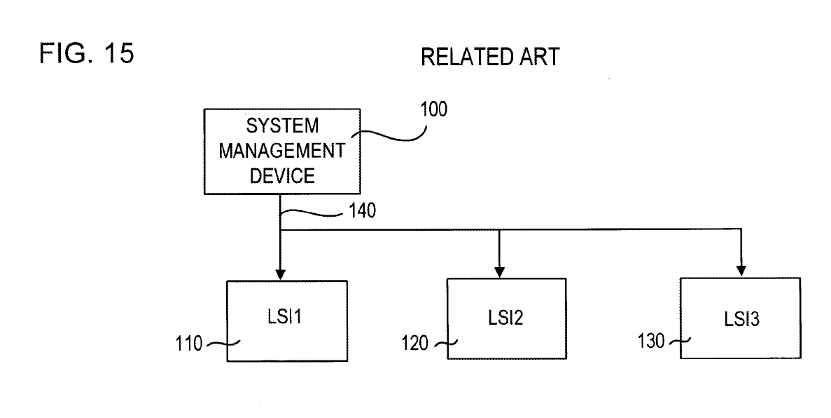

FIG. 14 is a block diagram of the electronic system according to another embodiment. FIG. 14 illustrates a CPU/memory board. As illustrated in FIG. 14, the CPU/memory board includes a CPU (arithmetic processing unit: Central Processing Unit), a plurality of memory access controller (MAC) 6, 6-1 and 6-2 and a plurality of memory 8-1˜8-3. The CPU 7 has one or more CPU's.

Each memories 8-1˜8-3 is constructed by a RAM (Random Access Memory). This memory 8-1 to 8-3 is preferably configured of a DIMM (Dual Inline Memory Module).

A first memory access controller 6 connects to a first memory 8-1 and performs read/write control of the first memory 8-1 according to an instruction of the CPU7. A second memory access controller 6-1 connects to a second memory 8-2 and performs read/write control of the second memory 8-2 according to an instruction of the CPU7. A third memory access controller 6-2 connects to a third memory 8-3 and performs read/write control of the third memory 8-3 according to an instruction of the CPU7.

The memory access controllers 6, 6-1 and 6-2 requires the set value corresponding to a type of memory which is connected, a speed of the memory, and the number of memory, for example. The memory access controllers 6, 6-1 and 6-2 store the setting value into the register and adjust the timing and the like of the read/write of the functional circuit (memory access circuit).

In the embodiment, the CPU/memory board is provided a non-volatile memory (PROM) 5 storing the setting values for each memory access controller. And the nonvolatile memory 5 connects to the first memory access controller 6. The first memory access controller 6 connects to the second memory access controller 6-1 via the signal line S1, the second memory access controller 6-1 connects to the third memory access controller 6-2 via the signal line S2.

That is, the master LSI 2 described in FIG. 1 and FIG. 2 corresponds to the first memory access controller 6 and the slave LSI 3 and 4 correspond to the second and third memory access controllers 6-1 and 6-2. Therefore, initialization of the registers in the memory access controllers 6, 6-1 and 6-2 can be carried out to restore the data strobe and to transfer data as described in FIG. 1 to FIG. 12.

As the signal lines S1 and S2, above described side band signal lines are used. The memory access controllers 6, 6-1 and 6-2 perform notification such as an error via the sideband signal line during a normal operation. Because the signal line is not required for the independent initial setting by using the sideband signal line, it is possible to reduce the design cost. Further, because it does not depend on the system management device, it is possible to reduce the complexity of the system and to reduce the design effort. In addition, because each system is expected to use a share of the initialization control circuit 6 and 6-1, it is possible to reduce the design effort.

The embodiment was described in a case of using the signal line of side-band, but the signal line was not limited thereto and may be applied to the other signal line which connects the LSI.

### Other Embodiments

The above embodiment has been described in the example of initialization of the memory access controller, but the initialization process may be applied to initialization of the CPU or other functional circuit.

The foregoing has described the embodiments of the present invention, but within the scope of the spirit of the present invention, the present invention is able to various modifications, and it is not intended to exclude them from the scope of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention has been described in detail, it should be understood that the various changes, substitutions, and alterations could be made hereto without departing from the spirit and scope of the invention.

What is claimed is:

1. An electronic system comprising:
a plurality of semiconductor integrated circuit devices that are connected each other by a single signal line and has a functional circuit which performs a predetermined function by setting data; and
a storage unit that stores the setting data of each of the plurality of semiconductor integrated circuit device,
wherein one semiconductor integrated circuit device of the plurality of semiconductor integrated circuit devices comprises an initialization control circuit that sequentially reads the setting data of each of the plurality of the semiconductor integrated circuit devices from the storage unit, sets the setting data of the one semiconductor integrated circuit device to the functional circuit of the one semiconductor integrated circuit device, and transfers second setting data of another semiconductor integrated circuit device to the another semiconductor integrated circuit device via the single signal line.

2. The electronic system according to claim 1, wherein the another semiconductor integrated circuit device comprises a second initialization circuit that receives a strobe signal from the one semiconductor integrated circuit device via the single signal line, restores a second strobe signal based on the strobe signal which is received, and captures the second setting data into a register based on the second strobe signal.

3. The electronic system according to claim 1, wherein the initialization circuit comprises:
a shift register that captures the setting data; and
a control circuit that determines whether captured setting data is the setting data of the one semiconductor integrated circuit device or second setting data of the another semiconductor integrated circuit device, sets the setting data of the one semiconductor integrated circuit device to the functional circuit of the one semiconductor integrated circuit device, and transfers the second setting data of another semiconductor integrated circuit device to the another semiconductor integrated circuit device via the single signal line.

4. The electronic system according to claim 3, wherein the initialization circuit further comprises a strobe signal generation circuit that generates a strobe signal to transfer to the another semiconductor integrated circuit.

5. The electronic system according to claim 1, wherein the control circuit analyzes one portion of the setting data, and determines whether captured setting data is the setting data of the one semiconductor integrated circuit device or the second setting data of the another semiconductor integrated circuit device.

6. The electronic system according to claim 2, wherein the second initialization circuit comprises:
a shift register that captures the setting data; and
a control circuit that determines whether captured setting data is the second setting data of the another semiconductor integrated circuit device or third setting data of other semiconductor integrated circuit device that is connected to another semiconductor circuit device via a second signal line, sets the second setting data in the shift register to the functional circuit of the another semiconductor integrated circuit device, and transfers the third setting data of the other semiconductor integrated circuit device to the other semiconductor integrated circuit device via the second signal line.

7. The electronic system according to claim 6, wherein the second initialization circuit further comprises a strobe signal generation circuit that generates a strobe signal to transfer the other semiconductor integrated circuit.

8. The electronic system according to claim 6, wherein the control circuit of the another semiconductor integrated circuit device analyzes one portion of the setting data, and determines whether captured setting data is the second setting data of the another semiconductor integrated circuit device or the third setting data of the other semiconductor integrated circuit device.

9. The electronic system according to claim 1, wherein the single signal line comprises a signal line that communicates between the functional circuits of each semiconductor integrated circuit device.

10. A semiconductor integrated circuit device comprises:
a functional circuit that performs a predetermined function by setting data which has been set; and
an initialization control circuit that sequentially reads the setting data of each of a plurality of the semiconductor integrated circuit devices from a storage unit that stores the setting data of each of the semiconductor integrated circuit device, sets the setting data of the functional circuit in the semiconductor integrated circuit device to the functional circuit of the semiconductor integrated circuit device, and transfers second setting data of the functional circuit in another semiconductor integrated circuit device to the another semiconductor integrated circuit device via a signal line.

11. The semiconductor integrated circuit device according to claim 10, wherein the initialization circuit comprises:
a shift register that captures the setting data; and
a control circuit that determines whether captured setting data is the setting data of the one semiconductor integrated circuit device or second setting data of the another semiconductor integrated circuit device, sets the setting data of the one semiconductor integrated circuit device to the functional circuit of the one semiconductor integrated circuit device, and transfers the second setting data of another semiconductor integrated circuit device to the another semiconductor integrated circuit device via the single signal line.

12. The semiconductor integrated circuit device according to claim 10, wherein the initialization circuit further comprises a strobe signal generation circuit that generates a strobe signal to transfer the another semiconductor integrated circuit.

13. The semiconductor integrated circuit device according to claim 11, wherein the control circuit analyzes one portion of the setting data, and determines whether captured setting data is the setting data of the one semiconductor integrated circuit device or the second setting data of the another semiconductor integrated circuit device.

14. The semiconductor integrated circuit device according to claim 10, wherein the single signal line comprises a signal line that communicates between the functional circuits of each semiconductor integrated circuit device.
